(19) United States
(12) Patent Application Publication
(10) Pub. No.: US 2009/0239432 A1
(43) Pub. Date: Sep. 24, 2009

(54) Gas permeable non-woven fabric based film for extending the shelf life of fresh fruits & vegetables and vase life of fresh cut flowers

(76) Inventor: Shubham Chandra, Milford, MA (US)

Correspondence Address: Shubham Chandra, 20 Zain Circle, Milford, MA, 01757, US

(21) Appl. No.: 12/051,844

(22) Filed: Mar. 19, 2008

(51) Int. Cl. B32B 5/18; B65D 85/00

(52) U.S. Cl. 442/76; 206/7

(57) ABSTRACT

Packaging using Gas Permeable Non-Woven Fabric based Film extends the shelf life of various fresh fruits and vegetables and vase life of fresh cut flowers by changing the atmosphere in which these living products are stored and respires. The high oxygen and carbon dioxide permeability of the Gas Permeable Non-Woven Fabric based Film establishes an ideal atmosphere for the specific perishable item, and therefore extends its shelf life. The establishment of lower oxygen and carbon dioxide atmospheres inside packages using Gas Permeable Non-Woven Fabric based film, also leads to reduction in the respiration rate of the perishable items. The reduction in the respiration rate prevents loss of moisture, production of metabolic heat, and yellowing, browning, reduction in production levels of ethylene. Thus the created atmosphere is able to extend shelf life, maintain high quality and preserve nutrients of fresh produce items by naturally regulating respiration of said produce/flower.

### BACKGROUND OF THE INVENTION

1. Field of the Invention

The invention relates to a Gas Permeable Non-Woven Fabric based Film with high permeability towards oxygen and carbon dioxide, and is directed more particularly to such a packaging system as is suitable for extending the shelf life of fresh fruits and vegetables (both whole and fresh cut), and vase life of flowers.

2. Description of the Prior Art

Produce is a living tissue that derives energy primarily by exchanging gases with its surroundings through the process of respiration. Respiration involves the consumption of atmospheric oxygen, carbohydrates, and organic acids by the plant tissue, and the consequent production and release of metabolic energy, heat, carbon dioxide and water vapor.

The packaging systems provided in the art range from basic low density polyethylene bags to fairly sophisticated high oxygen transmission rate gas permeable membranes.

Some shortcomings of such packaging systems include the inability to establish ideal oxygen and carbon dioxide atmosphere levels inside the packaging simultaneously. Typically, since the permeation rate for such packages for oxygen and carbon dioxide is same, if the oxygen atmosphere inside the package is 5% the carbon dioxide atmosphere will be 21−5=16%. So in essence the sum of oxygen and carbon dioxide levels will be 21%. Therefore, atmospheres such as 2% Oxygen and 5% Carbon Dioxide cannot be achieved.

Further, many of the packaging systems in use control and/or inhibit the growth of ethylene levels inside the package containing produce. Ethylene is a ripening agent, which is produced naturally in fresh fruits and vegetables as they respire. However, controlling the ethylene levels does not guarantee shelf life or for that matter vase life extension, because the oxygen levels and carbon dioxide levels need to be controlled simultaneously. Reduced oxygen levels caused increased metabolic activity and hence reduction in shelf life, and increased carbon dioxide levels leads to tissue softening, and fungal and bacterial growth.

Still further, use of polyethylene bags do not have the adequate permeability needed for long term storage of produce and/or flowers. Issues such as development of anaerobic conditions when the oxygen levels go below 1% and development of high carbon dioxide levels permanently injure the produce; make the use of low density plastic bags incapable in shelf life extensions.

Accordingly, there remains room for improvement in many areas of shelf life and vase life extension technologies.

### SPECIFICATIONS/SUMMARY OF THE INVENTION

An objective of the invention is, therefore, to provide a packaging system with a high permeable polymer coated non-woven fabric, which in essence by naturally establishing modified atmospheres inside a package containing fresh produce/flower can effectively extends its shelf/vase life.

Produce is a living tissue that derives energy primarily by exchanging gases with its surroundings through the process of respiration. Respiration involves the consumption of atmospheric oxygen, carbohydrates, and organic acids by the plant tissue, and the consequent production and release of metabolic energy, heat, carbon dioxide and water vapor.

Thus the created atmosphere is able to extend shelf life, maintain high quality and preserve nutrients of fresh produce items by regulating the respiration of the targeted items. Gas Permeable Non-Woven Fabric based Film, which allows for Carbon Dioxide gas to move in and out of the packaging at a rate many times greater than that of Oxygen. By reducing the atmospheric levels of Oxygen and increasing the atmospheric levels of Carbon Dioxide within the packaging, the ripening of fresh produce and fresh cut flowers can be delayed, the produce's respiration and ethylene production rates can be reduced, the softening of the produce can be retarded, and various compositional changes associated with produce ripening can be slowed down.

The highly permeable non woven fabric based film is obtained by coating nonwoven fabric such as one with 50% polyester and 50% rayon, with a thin layer of polymer, the fabric based system gets its structural strength from the fabric and the permeability from the polymer. This discovery has enabled us to reduce the thickness of the polymer coating on the fabric, and yet maintain enough strength with the fabric, and therefore enhancing its Oxygen Permeation Rate to 110,000 cc/100 in2/day/atm, or even up to 611,111 cc/100 in2/day/atm, with carbon dioxide permeability of at least 350,000 cc/100 in2/day/atm, with a maximum permeability of 3,888,889 cc/100 in2/day/atm at 13° C.

With the above and other objects in view, as will hereinafter appear, a feature of the present invention is the provision of a packaging system including a polyethylene bag, with a hole cutout at the center of the bag, thereof adapted to receive a permeable film, including an adhesive patch for binding the film to the cutout part of the plastic bag, an elastic band for closing the mouth of the plastic bag.

Gas Permeable Non-Woven Fabric Based Film Fabrication Process
a. The first step is making these Gas Permeable Non-Woven Fabric based Films. For the creation of these films, the components needed are polydimethyl siloxane (PDMS) base (This polydimethyl siloxane either consists of >60.0% Dimethyl siloxane, dimethylvinyl-terminated, 30.0-60.0% Dimethylvinylated and trimethylated silica, and 1.0-5.0% Tetra(trimethylsiloxy) silane, or >60.0% Dimethyl siloxane, dimethylvinyl-terminated and 30.0-60.0% Dimethylvinylated and trimethylated silica.), and curing agent mixed in the ratio 10:1, non-woven fabric (50% polyester, 50% Rayon), Mylar Rod (#3, which creates a film thickness of 0.27 MIL) were used.
b. Mix the PDMS base and curing agent in a 10:1 ratio measured by weight
c. De-gas the polymer in a desiccator for approximately 30 minutes. This removes any air bubbles resulting from the mixing process.
d. Pour this mixture on a non woven fabric, and roll the Mylar Rod #3 to form a uniform spread. Mylar rod #3 deposits a thickness of 0.27 MIL on the fabric.
e. Preheat oven for 20 minutes at 170° F. (76.6° C.).
f. Cure the PDMS-coated fabric at 170° F. (76.6° C.) for 20 minutes to promote cross-linking.

Process to design packages using the Gas Permeable Non-Woven Fabric based film. The respiration rates, ideal atmospheres, and ethylene sensitivities for various perishable items, including fresh fruits and vegetables and fresh cut flowers have been documented by University of California, Davis. The information available was utilized in designing these packages.
a. Identify the perishable item that is to have a shelf life extension. Items identified and tested have included, broccoli, cilantro, bananas, whole corn, lettuce, tomatoes, red seedless grapes, mushrooms, strawberries and cut flowers (roses, orchids, gerbera and tulips).
b. For example sake, if we were to pick banana, the respiration rates, ideal atmospheres and ideal storage temperatures were identified. The Oxygen transmission Rates (OTR) and Carbon Dioxide transmission Rates (COTR) for the Gas Permeable Non-Woven Fabric based film have already been tested by an independent test agency, Mocon Inc. Measure the weight of produce, bananas. Using the weights, respiration rates, ideal atmospheres, COTR and OTR of these films, the surface area needed for these films can be calculated. Take the produce bag, can be low density polyethylene bag (LDPE), high density polyethylene bag (HDPE), or any other non-porous material based, used to store bananas, and cut a hole in the bag equivalent to the surface area needed for the film.
c. Using a good adhesive tape (currently using the electrical insulating tape, 3M), attach the Gas Permeable Non-Woven Fabric based film at the position where the produce bag has a hole.
d. Place the produce, banana inside the bag.
e. Using a regular elastic band close the opening of the produce bag.

The produce bag with the Gas Permeable Non-Woven Fabric based Films will naturally attain the ideal atmospheres needed for bananas, and therefore will extend its shelf life. Testing results have successfully been able to extend the life of bananas to 20+ days.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

Reference is made to the accompanying drawings in which is shown an illustrative embodiment of the invention, from which its novel features and advantages will be apparent.

In the drawings:

FIG. 1 is a simplified illustration of one form of packaging system with the Gas Permeable Non-Woven Fabric based Film illustrative of an embodiment of the invention;

FIG. 2 is a an illustration an enlarged view of matter in circle A of FIG. 1;

FIG. 3 is an illustration of the Gas Permeable Non-Woven Fabric based film;

### DESCRIPTION OF THE PREFERRED EMBODIMENTS

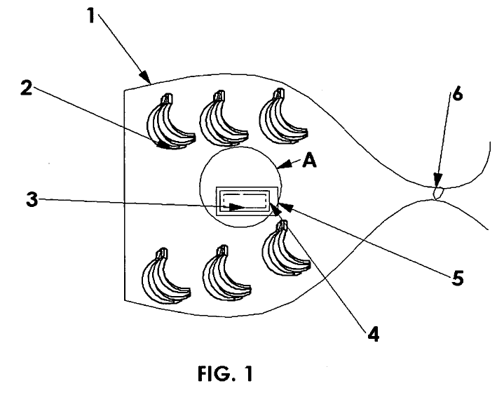

Referring to FIG. 1, it will be seen that an illustrative includes a non-perforated polyethylene bag I with perishable item 2, with a hole cutout 3 at the center of the bag, thereof adapted to receive a permeable film 4, including an adhesive patch 5 for binding the permeable film to the cutout part of the plastic bag, an elastic band 6 for closing the mouth of the plastic bag.

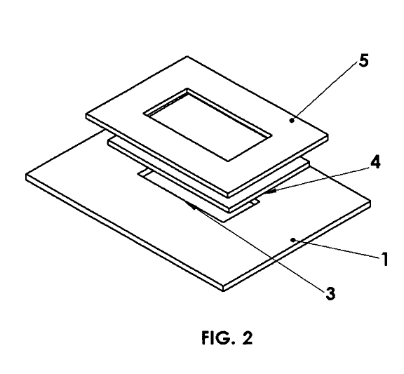

FIG. 2 is an enlarged view of matter in circle A of FIG. 1;

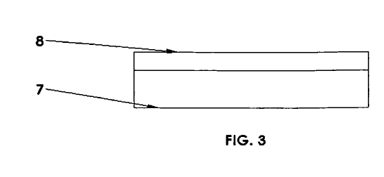

Referring to FIG. 3, it will be seen that an illustrative includes a nonwoven fabric 7 (50% polyester, 50% Rayon) with a coating of polymer 8 consisting of polydimethyl siloxane either consists of >60.0% Dimethyl siloxane, dimethylvinyl-terminated, 30.0-60.0% Dimethylvinylated and trimethylated silica, and 1.0-5.0% Tetra(trimethylsiloxy) silane, or >60.0% Dimethyl siloxane, dimethylvinyl-terminated and 30.0-60.0% Dimethylvinylated and trimethylated silica, and curing agent mixed in the ratio 10:1.

What is claimed is:

1. A Gas Permeable Non-Woven Fabric based Film with high permeability towards oxygen and carbon dioxide, and is directed more particularly to such a packaging system as is suitable for extending the shelf life of fresh fruits and vegetables (both whole and fresh cut), and vase life of flowers, consisting of
a. a nonwoven fabric such as one containing 50% polyester and 50% rayon, which allows for easier transmission of gases such as oxygen and carbon dioxide
b. a polymer coating on the nonwoven fabric, with thicknesses ranging between 0.18 MIL to 2 MIL dependent upon the produce, and its weight
i. the polymer coating has an oxygen permeability of at least 55,000 cc/100 in2/day/atm, with a maximum permeability of 611,111 cc/mil/100 in2/day/atm at 13° C.
ii. the polymer coating has a carbon dioxide permeability of at least 350,00 cc/100 in2/day/atm, with a maximum permeability of 3,888,889 cc/100 in2/day/atm at 13° C.

2. Using packages designed with Gas Permeable Non-Woven Fabric based film; shelf life of ethylene treated banana, can be extended up to 16+ days. Typical life of ethylene treated bananas is 4 days; shelf life of ethylene untreated banana can be extended up to 30+ days. The packaging consists of a non-perforated polyethylene bag with banana, with a hole cutout at the center of the bag, thereof adapted to receive the Gas Permeable Non-Woven Fabric based film, including an adhesive patch for binding the Gas Permeable Non-Woven Fabric based film to the cutout part of the plastic bag, an elastic band for closing the mouth of the non-perforated plastic bag.

3. Using packages designed with Gas Permeable Non-Woven Fabric based film; shelf life of mango, can be extended up to 18 days. Typical life of mangos is 7 days. The packaging consists of a non-perforated polyethylene bag with mango, with a hole cutout at the center of the bag, thereof adapted to receive the Gas Permeable Non-Woven Fabric based film, including an adhesive patch for binding the Gas Permeable Non-Woven Fabric based film to the cutout part of the plastic bag, an elastic band for closing the mouth of the non-perforated plastic bag.

4. Using packages designed with Gas Permeable Non-Woven Fabric based film; shelf life of whole corn, can be extended up to 16 days. Typical life of whole corn is 5-7 days. The packaging consists of a non-perforated polyethylene bag with corn, with a hole cutout at the center of the bag, thereof adapted to receive the Gas Permeable Non-Woven Fabric based film, including an adhesive patch for binding the Gas Permeable Non-Woven Fabric based film to the cutout part of the plastic bag, an elastic band for closing the mouth of the non-perforated plastic bag.

5. Using packages designed with Gas Permeable Non-Woven Fabric based film; shelf life of tomato, can be extended up to 21 days. The packaging consists of a non-perforated polyethylene bag with tomato, with a hole cutout at the center of the bag, thereof adapted to receive the Gas Permeable Non-Woven Fabric based film, including an adhesive patch for binding the Gas Permeable Non-Woven Fabric based film to the cutout part of the plastic bag, an elastic band for closing the mouth of the non-perforated plastic bag.

6. Using packages designed with Gas Permeable Non-Woven Fabric based film; shelf life of fresh cut roses, can be extended up to 8+ days. Typical life of roses is 2-4 days. The packaging consists of a non-perforated polyethylene bag with cut roses, with a hole cutout at the center of the bag, thereof adapted to receive the Gas Permeable Non-Woven Fabric based film, including an adhesive patch for binding the Gas Permeable Non-Woven Fabric based film to the cutout part of the plastic bag, an elastic band for closing the mouth of the non-perforated plastic bag.

7. Using packages designed with Gas Permeable Non-Woven Fabric based film, shelf life of coriander, seedless grapes, orchids, gerbera peas and green beans has also been extended. The packaging consists of a non-perforated polyethylene bag with items such as coriander, seedless grapes, orchids, gerbera and green beans, with a hole cutout at the center of the bag, thereof adapted to receive the Gas Permeable Non-Woven Fabric based film, including an adhesive patch for binding the Gas Permeable Non-Woven Fabric based film to the cutout part of the plastic bag, an elastic band for closing the mouth of the non-perforated plastic bag.
